(19) United States
(12) Patent Application Publication
(10) Pub. No.: US 2023/0032324 A1
(43) Pub. Date: Feb. 2, 2023

(54) METHOD FOR TRAINING DECISION-MAKING MODEL PARAMETER, DECISION DETERMINATION METHOD, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Fan WANG, Beijing (CN); Hao TIAN, Beijing (CN); Haoyi XIONG, Beijing (CN); Hua WU, Beijing (CN); Jingzhou HE, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 17/966,127

(22) Filed: Oct. 14, 2022

(30) Foreign Application Priority Data
Apr. 6, 2022 (CN) 2022103567333

(51) Int. Cl. G06N 20/00

(52) U.S. Cl. CPC G06N 20/00; G06V 10/774

(57) ABSTRACT

A method for training a decision-making model parameter, a decision determination method, an electronic device, and a non-transitory computer-readable storage medium are provided. In the method, a perturbation parameter is generated according to a meta-parameter, and first observation information of a primary training environment is acquired based on the perturbation parameter. According to the first observation information, an evaluation parameter of the perturbation parameter is determined. According to the perturbation parameter and the evaluation parameter thereof, an updated meta-parameter is generated. The updated meta-parameter is determined as a target meta-parameter, when it is determined, according to the meta-parameter and the updated meta-parameter, that a condition for stopping primary training is met. According to the target meta-parameter, a target memory parameter corresponding to a secondary training task is determined, where the target memory parameter and the target meta-parameter are used to make a decision corresponding to a prediction task.

### CROSS-REFERENCE TO RELATED APPLICATION

This application claims priority to Chinese Pat. Application No. 202210356733.3, filed on Apr. 6, 2022, which is hereby incorporated by reference in its entirety.

### TECHNICAL FIELD

The present disclosure relates to deep learning technologies in the field of artificial intelligence, and particularly to a method for training a decision-making model parameter, a decision determination method, an electronic device, and a non-transitory computer-readable storage medium.

### BACKGROUND

In the field of artificial intelligence, an initial model is generally obtained through pre-training with training data, and secondary training is performed on the initial model with training data corresponding to a specific training task, to obtain a model corresponding to the specific training task.

In order to avoid a high training cost that is caused by preparing a large amount of high-quality training data for the secondary training, it is necessary to provide a solution that enables model training to be performed without preparing the high-quality training data.

### SUMMARY

Embodiments of the present disclosure provide a method for training a decision-making model parameter, a decision determination method, an electronic device, and a non-transitory computer-readable storage medium, by which a model training process can be implemented without preparing high-quality training data.

According to a first aspect of the present disclosure, there is provided a method for training a decision-making model parameter, implemented by an electronic device, the method including:
acquiring an initialized meta-parameter;
generating a perturbation parameter according to the meta-parameter, and acquiring first observation information of a primary training environment based on the perturbation parameter;
determining, according to the first observation information, an evaluation parameter of the perturbation parameter;
generating, according to the perturbation parameter and the evaluation parameter thereof, an updated meta-parameter;
determining the updated meta-parameter as a target meta-parameter, in response to determining, according to the meta-parameter and the updated meta-parameter, that a condition for stopping primary training is met; and
determining, according to the target meta-parameter, a target memory parameter corresponding to a secondary training task, where the target memory parameter and the target meta-parameter are configured to make a decision corresponding to a prediction task, and prediction task corresponds to the secondary training task.

According to a second aspect of the present disclosure, there is provided a decision determination method, implemented by an electronic device, the method including:
acquiring current observation information;
determining, according to a preset target meta-parameter and a preset target memory parameter, a decision corresponding to the current observation information; and
executing the decision;
where the preset target meta-parameter and the preset target memory parameter are obtained through training based on the method according to the first aspect.

According to a third aspect of the present disclosure, there is provided an electronic device, including:
at least one processor; and
a memory communicating with the at least one processor;
where the memory stores therein instructions executable by the at least one processor, and the instructions are executed by the at least one processor to cause the at least one processor to perform the method according to the first aspect.

According to a fourth aspect of the present disclosure, there is provided a non-transitory computer-readable storage medium storing computer instructions, where the computer instruction, when being executed by an electronic device, cause the electronic device to perform the method according to the first aspect.

It should be understood that the contents described in this section are not intended to identify key or critical features of the embodiments of the present disclosure, nor are they intended to limit the scope of the present disclosure. Other features of the present disclosure will become readily understood from the following description.

### BRIEF DESCRIPTION OF THE DRAWINGS

The accompanying drawings are provided for better understanding of the solutions, and they do not constitute a limitation to the present disclosure, in which:

FIG. 1 is a schematic flowchart of a method for training a decision-making model parameter provided by an exemplary embodiment of the present disclosure.

FIG. 2 is a schematic flowchart of a method for training a decision-making model parameter provided by another exemplary embodiment of the present disclosure.

FIG. 3 is a schematic flowchart of a decision determination method provided by an exemplary embodiment of the present disclosure.

FIG. 4 is a schematic structural diagram of an apparatus for training a decision-making model parameter provided by an exemplary embodiment of the present disclosure.

FIG. 5 is a schematic structural diagram of an apparatus for training a decision-making model parameter provided by another exemplary embodiment of the present disclosure.

FIG. 6 is a schematic structural diagram of a decision determination apparatus provided by an exemplary embodiment of the present disclosure.

FIG. 7 is a block diagram of an electronic device for implementing the methods provided by the embodiments of the present disclosure.

### DESCRIPTION OF EMBODIMENTS

The exemplary embodiments of the present disclosure are described below with reference to the accompanying drawings, including various details of the embodiments of the present disclosure that are useful for understanding the present disclosure, which should be considered as merely exemplary. Therefore, those of ordinary skill in the art should realize that various changes and modifications may be made to the embodiments described herein without departing from the scope and spirit of the present disclosure. Likewise, for clarity and conciseness, descriptions of well-known functions and structures are omitted below.

At present, there is transfer learning technique that can improve the efficiency of model training. Some data may be used to perform pre-training to obtain an initial model, and then targeted secondary training may be performed on the initial model to obtain a model that may be applied to a specific task.

For example, an initial model may be obtained through pre-training with a large number of images, and there is no limitation on the contents included in these images. After the initial model is obtained, targeted training may be performed on the initial model. For example, secondary training is performed, with face images, on the initial model to obtain a model capable of performing face detection. For another example, the secondary training is performed, with vehicle images, on the initial model to obtain a model capable of performing vehicle detection.

In performing the secondary training on the initial model, it is necessary to prepare training data for specific training tasks, and the quality of the training data is required to be high. This leads to a high cost of performing secondary training of the model, and this results in a problem that ordinary users cannot perform secondary training on the model due to higher requirements for users’ professionalism.

In order to solve the above technical problem, in the solutions provided by the present disclosure, model training may be performed in a primary training environment, to obtain a target meta-parameter through learning. Based on the target meta-parameter, training is performed in a secondary training environment, to obtain a target memory parameter through learning. As such, the target memory parameter and the target meta-parameter are used to make a decision corresponding to the secondary training environment. In such solutions, the training process does not rely on training data prepared in advance, rather, it uses data observed from the environment and the response to the environment, to obtain trained parameters of the model, thereby improving the training efficiency.

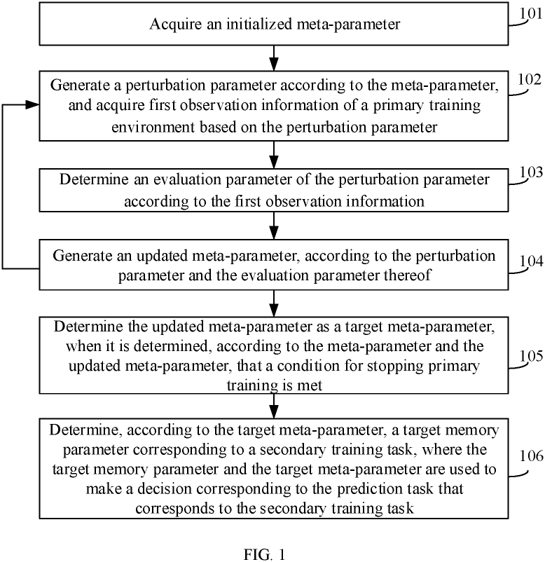

FIG. 1 is a schematic flowchart of a method for training a decision-making model parameter provided by an exemplary embodiment of the present disclosure.

As shown in FIG. 1, the method for training a decision-making model parameter provided by the embodiment of the present disclosure includes operations as follows.

At step 101, an initialized meta-parameter is acquired.

The solutions provided by the present disclosure may be applied to an electronic device with computing capability, and the electronic device may be, for example, a robot, an in-vehicle terminal, or a computer.

Specifically, the electronic device may acquire observation information, and make a response to the observation information based on internal parameters. The observation information may be for example an image, a sentence, and external environment information. For example, the electronic device may be provided with an image recognition module, in this case, the electronic device may acquire an external image and use the image recognition module to recognize the acquired external image. For another example, the electronic device may acquire external environment information, and make a decision based on the acquired external environment information. Further, the electronic device may have stored therein a meta-parameter, and the meta-parameter may be optimized through multiple iterations, such that the electronic device may make decisions according to the meta-parameter.

In practical applications, the electronic device may not have the meta-parameter when no training is performed, and the meta-parameter may be obtained through initialization when the training is started. For example, the dimension of the meta-parameter may be preset, so that the electronic device may obtain the meta-parameter of the corresponding dimension through initialization.

At step 102, a perturbation parameter is generated according to the meta-parameter, and first observation information of a primary training environment is acquired based on the perturbation parameter.

In order to increase the amount of data generated in the training process, the perturbation parameter may be generated according to the meta-parameter. For example, a noise value may be added with the meta-parameter, to obtain the perturbation parameter.

Specifically, multiple perturbation parameters may be generated for one meta-parameter. For example, for a meta-parameter θₖ, n perturbation parameters θₖ¹, θk², θₖ³...θₖⁿ may be generated. In an implementation, the dimension of each perturbation parameter is the same as that of the meta-parameter.

Further, the electronic device may collect information about the primary training environment where it is located. The training environment refers to an environment used to train a model, and the primary training environment refers to an environment in which the primary training is performed on the model. The electronic device may make a decision, and perform an action based on that decision. After that, the information of the training environment collected by the electronic device once again would be changed due to this respective action performed by the electronic device. For example, the information of the training environment may be a sentence, the electronic device generates response content to an input sentence based on the model, and the electronic device may also use the response content as a next input sentence.

For example, in a case where the electronic device is a vehicle, external environment information of the vehicle may be collected. In a case where the model to be trained is provided in the electronic device, the primary training environment refers to the environment of the electronic device, and the acquired information of the primary training environment refers to information that needs to be processed by the model to be trained. In this case, the electronic device acquires data input to the model.

The primary training environment may be a relatively general environment, and a task performed by the electronic device based on this environment may be multiple tasks, which may be relatively general tasks, such as picking up a target object, and monitoring.

In practical applications, the electronic device may generate, based on the perturbation parameter, decision information for responding to the observation information. For example, in a case where the electronic device is a robot, the decision information may be data for adjusting the posture of a joint; or in a case where the electronic device is a computer configured with image recognition software, the decision information may be used to cause the electronic device to perform recognition on the image to obtain a recognition result.

The electronic device may execute a decision based on the generated decision information, for example, it may perform a corresponding action or output the recognition result.

Specifically, after executing the decision based on the decision information, the electronic device may also acquire the first observation information of the primary training environment where it is located. For example, in a case where the electronic device moves forward one step based on the generated decision information, the electronic device may acquire the first observation information after the one step is moved. In a case where the electronic device is a hardware device, the first observation information may be collected by a sensor provided on the electronic device. The first observation information may also be data subsequently acquired by the electronic device, for example, it may be a next image frame in a video that is acquired once again after one image frame is recognized in the video.

Further, each time the electronic device generates a decision based on the current perturbation parameter and executes the decision, the electronic device may acquire the first observation information.

At step 103, an evaluation parameter of the perturbation parameter is determined according to the first observation information.

Further, the electronic device may evaluate the perturbation parameter according to individual pieces of first observation information obtained for the perturbation parameter. For example, in a case where m decisions are made according to the perturbation parameter θₖ³, m pieces of first observation information may be acquired.

In practical applications, all the pieces of first observation information obtained for each perturbation parameter may be used to evaluate the perturbation parameter.

When the electronic device makes a decision based on the perturbation parameter, it has a certain purpose, such as for a purpose of getting closer to a target object, or getting further away from an obstacle. Therefore, it may be determined, according to the first observation information, whether the decision made by the electronic device is reasonable. For another example, it may be determined whether the logic between the response content output by the electronic device and the input sentence is reasonable.

For example, in a case where the electronic device is a robot, if it is determined from the pieces of first observation information that there are multiple collisions, the corresponding perturbation parameter may be evaluated to be poor; or if it is determined from the pieces of first observation information that there are few collisions, and the robot is approaching the target object gradually, the corresponding perturbation parameter may be evaluated to be good. For example, the evaluation parameter of the perturbation parameter may be a value indicating the degree of excellence.

Specifically, for each perturbation parameter, its corresponding evaluation parameter may be obtained. For example, n perturbation parameters θₖ¹, θₖ², θₖⁿ...θₖⁿ may be generated for perturbation parameter θₖ, and evaluation parameter rₖⁱ may be generated for each θₖⁱ.

At step 104, according to the perturbation parameter and the evaluation parameter thereof, an updated meta-parameter is generated.

Further, the individual perturbation parameters and the evaluation parameters thereof may be used to generate the updated meta-parameter.

For example, n perturbation parameters are obtained based on meta-parameter θₖ, and n evaluation parameters may be obtained accordingly. The n perturbation parameters and their respective n evaluation parameters may be used to generate the updated meta-parameter.

In practical applications, the evaluation parameter may be used to determine an iterative direction, so as to generate the updated meta-parameter that is more applicable to the environment set for the electronic device. In this implementation, at least one perturbation parameter that enables a good decision to be made may be selected, and then the meta-parameter may be updated according to such selected parameter(s), so that the meta-parameter applicable to the environment of the electronic device may be generated through multiple iterations.

For example, the updated meta-parameter may be generated according to some perturbation parameters which are evaluated to be relatively good, for example, a mean value of these perturbation parameters is determined as the updated meta-parameter.

At step 105, the updated meta-parameter is determined as a target meta-parameter, when it is determined, according to the meta-parameter and the updated meta-parameter, that a condition for stopping the primary training is met.

After the meta-parameter is updated, it may also be compared with the meta-parameter before this updating, to determine whether the updated meta-parameter meets the condition for stopping the primary training.

For example, if the updated meta-parameter and the meta-parameter before updating are relatively close to each other, it may be determined that the condition for stopping the primary training is met, and the updated meta-parameter may be used as the target meta-parameter.

Specifically, if the condition for stopping the primary training is not met, it may proceed to step 102 to perform operations therefrom with the updated meta-parameter. In this way, the target meta-parameter may be obtained through multiple iterations.

Further, after the target meta-parameter is obtained, a secondary training environment may be deployed for the electronic device, so that the electronic device may use the target meta-parameter to learn in the secondary training environment, so as to adapt to the training task of the secondary training environment.

At step 106, according to the target meta-parameter, a target memory parameter corresponding to a secondary training task is determined, where the target memory parameter and the target meta-parameter are used to make a decision corresponding to a prediction task, and the prediction task corresponds to the secondary training task.

In practical applications, the electronic device may obtain the target memory parameter through learning in the secondary training environment. Specifically, a memory parameter may be first obtained through initialization, and the electronic device may determine a decision based on the memory parameter and the target meta-parameter, and then execute the decision.

The memory parameter refers to a parameter obtained by the electronic device through learning in the secondary training environment, and it is a parameter used to perform a task corresponding to the secondary training environment. Through multiple iterations, the electronic device may obtain the target memory parameter through learning. During the multiple iterations, the memory parameter is updated, but the target meta-parameter is not updated.

After making a decision, the electronic device may collect information of the environment, and generate a new memory parameter, according to the current memory parameter, the target meta-parameter, the decision made by the electronic device, and the environment information collected after the decision is executed.

Specifically, a preset number of iterations may be performed to obtain the target memory parameter.

Further, after obtaining the target memory parameter, the electronic device may make decisions based on the target memory parameter and the target meta-parameter.

In this implementation, the data used to train the electronic device during the primary training and the secondary training is randomly generated, and it is unnecessary for the user to prepare the training data. Therefore, the training efficiency can be improved, and requirements for users’ professionalism are low.

The target meta-parameter may be obtained in the primary training process, where the target meta-parameter is a general parameter of the electronic device and may be applied in various environments. In the secondary training process, the electronic device may be trained in a specific environment, so as to obtain, through learning, the target memory parameter corresponding to the specific environment. As such, the electronic device may use the target meta-parameter and the target memory parameter to determine decisions.

In one application scenario, the electronic device may be for example a robot, the robot may perform a learning task in a primary training environment, so as to obtain the target meta-parameter through learning. And another learning task may be performed in a secondary training environment, so as to obtain the target memory parameter through learning.

For example, the primary training environment may have obstacles therein. The robot may collect environment information, make decisions based on a perturbation parameter corresponding to the current meta-parameter, and then execute the corresponding decisions. After that, the robot may collect environment information once again, and evaluate the current perturbation parameter according to the environment information collected once again; and then, update the meta-parameter based on the evaluation result. Such updating is performed through multiple iterations, until the target meta-parameter meeting the requirements is obtained through learning.

After obtaining the target meta-parameter through learning, the robot provided with the target meta-parameter may be placed in the secondary training environment. The robot makes decisions according to the target meta-parameter and the memory parameter to avoid obstacles in the secondary training environment. And the robot may also use the secondary environment information collected after executing the decisions, to update the memory parameter, until the target memory parameter applicable to the secondary training environment is obtained through learning.

For another example, in a case where the learning task performed by the robot is to avoid obstacles while walking, the robot may collect data of surrounding walls, make a walking route according to the perturbation parameter of the meta-parameter, and walk according to the walking route. The perturbation parameter may be evaluated according to a current location of the robot after walking according to the walking route, or be evaluated according to a time spent by the robot in arriving at a destination. Then, the meta-parameter may be updated based on the evaluation result. Such updating is performed through multiple iterations, until the target meta-parameter meeting the requirements is obtained through learning.

After obtaining the target meta-parameter through learning, the robot provided with the target meta-parameter may be placed in the secondary training environment. The robot makes decisions, according to the target meta-parameter and the memory parameter, to pass through a maze deployed in the secondary training environment. And the robot may also use data of the walls collected after executing the decisions, or the time spent in passing through the maze, to update the memory parameter, until the target memory parameter applicable to the secondary training environment is obtained through learning.

For another example, the robot may be a bipedal robot that can control a walking direction by controlling the postures of various joints. The robot makes decisions based on the current perturbation parameter corresponding to the meta-parameter, and executes the corresponding decisions. After that, the robot may collect the environment information once again, evaluate the perturbation parameter according to the environment information collected once again, and use the evaluation result to update the meta-parameter. For example, it may be determined, according to the environment information collected once again, whether it walks in an expected direction. After the updating of the meta-parameter is performed through multiple iterations, the target meta-parameter meeting the requirements may be obtained through learning.

After obtaining the target meta-parameter through learning, the robot provided with the target meta-parameter may be placed in the secondary training environment. The robot makes decisions based on the target meta-parameter and the memory parameter, to walk in the expected direction. In this way, even if the dynamic parameter of the robot set in the secondary training environment is different from that of the robot set in the primary training environment, for example the leg lengths are different, and the motor horsepower is different, the robot may quickly adapt to the secondary training environment. The target memory parameter applicable to the secondary training environment may be obtained through learning in multiple iterations.

In another application scenario, the electronic device may be for example a computer in which a model to be trained is provided. The electronic device configured with the model may perform a first learning task, and update the meta-parameter of the model to obtain the target meta-parameter through learning. After that, the electronic device configured with the model may perform a second learning task to obtain the target memory parameter through learning.

For example, the model is configured to perform artificial intellectual conversation. The electronic device may acquire a sentence as the first observation data, and make a decision by using a perturbation parameter corresponding to the meta-parameter of the model, where the decision may be a reply sentence. The model outputs the reply sentence. Then, the reply sentence is used as the first observation data of the model, so that the model generates a reply sentence once again. The perturbation parameter is evaluated based on the rationality between the first observation data and the reply sentence, and the meta-parameter is updated according to the evaluation result. After such updating of the meta-parameter is performed through multiple iterations, the target meta-parameter meeting the requirements may be obtained through learning.

After obtaining the target meta-parameter through learning, the model provided with the target meta-parameter may be used to perform a targeted learning task. For example, intellectual conversation sentences acquired in a financial environment are used to train the model. For another example, intellectual conversation sentences acquired in an after-sales consulting environment are used to train the model. In this way, the target memory parameter applicable to the financial environment may be obtained through learning, or the target memory parameter applicable to the after-sales consulting environment may be obtained through learning.

In the method for training a decision-making model parameter provided by the embodiment of the present disclosure, an initialized meta-parameter is acquired, a perturbation parameter according to the meta-parameter is generated, and first observation information of a primary training environment is acquired based on the perturbation parameter. According to the first observation information, an evaluation parameter of the perturbation parameter is determined. According to the perturbation parameter and the evaluation parameter thereof, an updated meta-parameter is generated. The updated meta-parameter is determined as a target meta-parameter, when it is determined, according to the meta-parameter and the updated meta-parameter, that a condition for stopping the primary training is met. According to the target meta-parameter, a target memory parameter corresponding to a secondary training task is determined, where the target memory parameter and the target meta-parameter are used to make a decision corresponding to a prediction task, and the prediction task corresponds to the secondary training task. With the method for training a decision-making model parameter provided by the embodiment of the present disclosure, during the primary training and the secondary training, there is no need to prepare training data in advance, the parameters are obtained through learning in multiple iterations performed by the electronic device without manual intervention, thus the training efficiency can be improved.

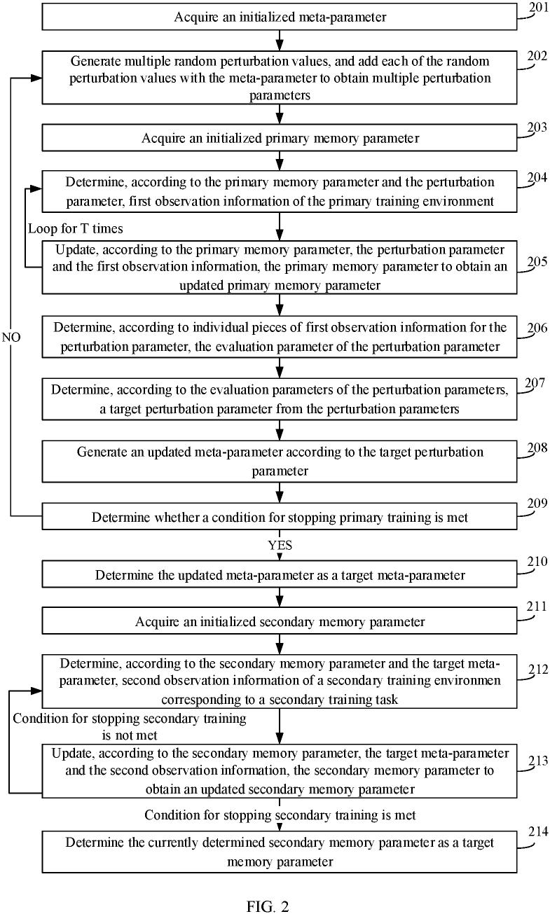

FIG. 2 is a schematic flowchart of a training method provided by another exemplary embodiment of the present disclosure.

As shown in FIG. 2, the method for training a decision-making model parameter provided by the present disclosure includes operations as follows.

At step 201, an initialized meta-parameter is acquired.

The implementation of step 201 is similar to that of step 101, which will not be repeated herein.

At step 202, multiple random perturbation values are generated, and each of the random perturbation values is added with the meta-parameter, so as to obtain multiple perturbation parameters.

The electronic device may generate multiple random perturbation values, for example, multiple random perturbation values may be determined based on a Gaussian distribution.

Specifically, the electronic device may add any of the random perturbation values with the meta-parameter, to obtain a respective perturbation parameter. In this way, multiple perturbation parameters may be obtained.

In this way, multiple perturbation parameters approximate to the meta-parameter may be obtained, so that according to these perturbation parameters, an optimization direction may be determined to update the meta-parameter. Finally, the meta-parameter applicable to multiple scenarios may be obtained, thereby improving the versatility of the meta-parameter.

For each of the perturbation parameters, a corresponding primary memory parameter may be obtained based on step 203 to step 205.

At step 203, an initialized primary memory parameter is acquired.

For any of the perturbation parameters, a primary memory parameter may be obtained through initialization. For example, for θₖⁱ, a primary memory parameter may be obtained through initialization. The primary memory parameter may be a specific value, or a parameter pool including multiple parameters.

At step 204, according to the primary memory parameter and the perturbation parameter, the first observation information of the primary training environment is determined.

The electronic device may obtain the current real-time observation information of the primary training environment where it is located, and make a decision for the current observation information according to the primary memory parameter and the perturbation parameter. And after executing the decision, the electronic device may acquire the current observation information of the primary training environment at that time as the first observation information.

For example, if a current task of the electronic device is to reach a destination to pick up a target object at there, the electronic device may determine a relative location of the target object with respect to itself based on the real-time observation information, and make a decision according to the primary memory parameter and the perturbation parameter, so that the electronic device may approach the target object by executing the decision. If the perturbation parameter and the primary memory parameter are applicable to the primary training environment where the electronic device is located, after executing the current decision, the electronic device may determine, by comparing the acquired first observation information with the previous real-time observation information, that the electronic device is getting close to the target object.

Specifically, the primary memory parameter may be updated, and each time a new primary memory parameter is obtained through updating, a piece of first observation information may be determined according to the current/new primary memory parameter and the perturbation parameter.

For example, for perturbation parameter θₖⁱ, the memory parameter may be initialized as η₀, and a decision α₀ may be made by using θₖⁱ and η₀. After performing the decision α₀, the electronic device may collect information of the primary training environment to obtain the first observation information oₜ.

The decision αₜ may be determined based on the following formula:

$${a}_{t} = g \left({η}_{i ,}^{t} {θ}_{k}^{i}\right)$$

, where t is used to represent the number of iterations for the primary memory parameter.

Specifically, the electronic device may acquire the first current observation information of the primary training environment. For example, in a case where the electronic device has a sensor, the electronic device may use the sensor to collect information of the surrounding environment, so as to obtain the first current observation information.

Further, the electronic device may also generate primary decision information corresponding to the first current observation information, according to the primary memory parameter and the perturbation parameter. The primary decision information generated by the electronic device is used to make a response to the first current observation information observed by the electronic device. For example, in a case where the first current observation information indicates that there is an obstacle in front of the electronic device, the generated primary decision information may enable the electronic device to bypass the obstacle.

In practical applications, the electronic device may make a decision based on the primary decision information, such as walking forward or backward. After executing the decision, the electronic device may collect the first observation information of the primary training environment.

In this implementation, a large number of primary memory parameters may be generated for each perturbation parameter, and each primary memory parameter and the perturbation parameter may be used to make one primary decision, and the first observation information may be obtained after the decision is executed. Thereafter, the perturbation parameter is evaluated by using the first observation information corresponding to the perturbation parameter.

In this implementation, the perturbation parameter is used to represent a general parameter of the model, and the memory parameter is used to represent a parameter corresponding to the training environment. The meta-parameter of generality may be obtained according to the individual perturbation parameters. In this way, the meta-parameter may be applied in other training environments, and the electronic device is enabled to have generality.

At step 205, the primary memory parameter is updated according to the primary memory parameter, the perturbation parameter and the first observation information, to obtain an updated primary memory parameter.

Specifically, the electronic device may update the primary memory parameter to obtain the updated primary memory parameter.

After the updated primary memory parameter is obtained, it may proceed to step 204, and such process loops for T times until T pieces of first observation information are obtained.

Further, the electronic device may update the primary memory parameter according to the primary memory parameter, the perturbation parameter and the first observation information, so that the updated primary memory parameter is more applicable to the current primary training environment.

Based on this implementation, multiple primary memory parameters may be determined with one perturbation parameter, so that a small number of parameters may drive a large number of memory parameters. In addition, the first observation information may also be determined for each primary memory parameter. Thus, a large amount of first observation information may be used to evaluate the effect of the perturbation parameter.

When updating the primary memory parameter, the electronic device may specifically update it according to the primary memory parameter, the perturbation parameter, the primary decision information and the first observation information, to obtain the updated primary memory parameter.

Specifically, the primary memory parameter may be updated based on the following formula:

$${η}_{i}^{t + 1} = f \left({η}_{i}^{t} , {o}_{t} , {a}_{t} ; {θ}_{k}^{i}\right) .$$

At step 206, according to the individual pieces of first observation information of the perturbation parameter, the evaluation parameter of the perturbation parameter is determined.

By means of the above approach, multiple pieces of first observation information of each perturbation parameter may be obtained, where each piece of such observation information is the first observation information obtained by the electronic device through sensing the information of the surrounding environment after the electronic device makes a decision based on the perturbation parameter. Therefore, each piece of first observation information of the perturbation parameter may be used to evaluate the perturbation parameter.

The evaluation result is used to indicate whether the decision made by the electronic device based on the perturbation parameter is beneficial to the task performed by the electronic device, and whether it is helpful to complete the task performed by the electronic device. For example, in a case where the task performed by the electronic device is to pick up a target object, if the electronic device is getting closer to the target object after making a decision based on the perturbation parameter, it may be determined that the effect of the perturbation parameter is good.

Specifically, in the solution provided by the present disclosure, multiple primary memory parameters may be obtained through iteration, so that the electronic device may make decisions according to different primary memory parameters and the perturbation parameter. If the decisions made by the electronic device with different primary memory parameters are still beneficial to the performed task, it may be determined that the generality of the respective perturbation parameter is good. If the decisions made by the electronic device with a large part of the primary memory parameters are unbeneficial to the performed task, and only the decisions made by the electronic device with a small part of the primary memory parameters are beneficial to the performed task, it may be determined that the generality of the respective perturbation parameter is poor.

In this implementation, a large number of primary memory parameters are generated using each perturbation parameter, and multiple pieces of primary observation information are respectively obtained after decisions are made based on the perturbation parameter and different primary memory parameters. Therefore, a large amount of primary observation information obtained based on the perturbation parameter may be used to evaluate the generality of the perturbation parameter. Accordingly, the target meta-parameter with good generality may be obtained by using such perturbation parameters.

At step 207, according to the evaluation parameters of the perturbation parameters, at least one target perturbation parameter is determined from the perturbation parameters.

Further, multiple perturbation parameters may be generated using one meta-parameter, and a corresponding evaluation parameter may be generated for each perturbation parameter.

In practical applications, the evaluation parameter is used to evaluate the generality of the perturbation parameter. In the method provided by the present disclosure, the evaluation parameters of the perturbation parameters are used to determine the optimization direction of the meta-parameter, thereby obtaining the target meta-parameter with good generality.

The target perturbation parameter with good generality may be selected, according to the evaluation parameters of the individual perturbation parameters of one meta-parameter, from these perturbation parameters.

For example, several perturbation parameters with top-ranked evaluation parameters are used as target perturbation parameters. For example, m perturbation parameters with good generality may be used as the target perturbation parameters.

These perturbation parameters are generated based on the same meta-parameter, but the specific values of the perturbation parameters are different, and the evaluation results in terms of generality thereof are also different. Therefore, the evaluation parameters of the perturbation parameters may be used to select target perturbation parameters with good generality, and then these target perturbation parameters may be used for updating, to determine the meta-parameter with good generality.

At step 208, the updated meta-parameter is generated according to the at least one target perturbation parameter.

Specifically, the updated meta-parameter may be generated according to individual target perturbation parameters with good generality. For example, the mean value of the target perturbation parameters may be determined as the updated meta-parameter. For another example, the individual target perturbation parameters may be weighted and then averaged, to obtain the updated meta-parameter. For example, the target perturbation parameter(s) with better generality is/are assigned with a large weight, and the other target perturbation parameters may be assigned with a small weight, so that the updated meta-parameter obtained in this way may be more accurate.

At step 209, it is determined whether the condition for stopping the primary training is met.

Further, after obtaining the updated meta-parameter, the electronic device may also compare the updated meta-parameter with the meta-parameter before the current updating, to determine whether the condition for stopping the primary training is met.

In practical applications, if it is determined that the condition for stopping the primary training is met, step 210 may be performed. If it is determined that the condition for stopping the primary training is not met, it may proceed to step 202 to perform operations therefrom with the updated meta-parameter. That is, the above steps 202 to 209 are repeated in multiple iterations, and the target meta-parameter with good generality may be obtained through updating in the multiple iterations.

If the difference between the meta-parameter before the current updating and the updated meta-parameter is less than a preset parameter threshold, it is determined that the condition for stopping the primary training is met. If the difference between the updated meta-parameter and the meta-parameter before the current updating is small, it shows that it is meaningless to continue the updating, and that it is no longer likely to obtain an updated meta-parameter that differs greatly from the current meta-parameter. Therefore, it may be considered that the condition for stopping the primary training task is met, so as to avoid meaningless iterations for updating.

Specifically, the electronic device may also determine an evaluation parameter of the meta-parameter, according to the evaluation parameters of the perturbation parameters of the meta-parameter. If the difference between the evaluation parameter of the meta-parameter before the current updating and the evaluation parameter of the updated meta-parameter is smaller than a preset evaluation threshold, it is determined that the condition for stopping the primary training task is met, so as to avoid meaningless iterations for updating.

Further, the perturbation parameters are generated on the basis of the meta-parameter. Therefore, the evaluation parameter of the meta-parameter may be determined according to the evaluation parameters of the perturbation parameters, and the evaluation parameter of the meta-parameter is used to evaluate the generality of the meta-parameter. For example, the mean value of the evaluation parameters of the individual perturbation parameters may be determined as the evaluation parameter of the meta-parameter.

In practical applications, if the difference between the evaluation parameter of the updated meta-parameter and that of the meta-parameter before the current updating is small, it shows that it is meaningless to continue updating the meta-parameter, and that it is no longer likely to obtain an updated meta-parameter with better generality than the current meta-parameter. Therefore, it may be considered that the condition for stopping the primary training task is met.

At step 210, the updated meta-parameter is determined as the target meta-parameter.

After the target meta-parameter with good generality is obtained, the secondary training may be performed on the electronic device, so that the electronic device may perform tasks in the secondary training environment.

At step 211, an initialized secondary memory parameter is acquired.

The electronic device may be provided in the secondary training environment, so that the electronic device may be trained according to the target meta-parameter, to obtain the target memory parameter applicable to the secondary training environment.

During the secondary training, the electronic device may obtain a secondary memory parameter η₀ through initialization; for example, the secondary memory parameter may be a specific value, or a parameter pool including multiple parameters.

At step 212, according to the secondary memory parameter and the target meta-parameter, second observation information of the secondary training environment is determined, where the secondary training environment corresponds to the secondary training task.

Specifically, the secondary training environment may be a relatively specific environment, and the secondary training task is also a targeted task, for example, it may be a maintenance task.

Further, multiple secondary training environments may be set up for multiple electronic devices with the target meta-parameter, so that the electronic devices may learn the ability to perform different tasks in different environments.

For example, in a case where one secondary training environment is set for an electronic device and another secondary training environment is set for another electronic device, the two electronic devices may learn abilities to perform different tasks respectively.

During the secondary training, the target meta-parameter of the electronic device remains unchanged, and the target memory parameter is obtained through multiple iterations. Such target memory parameter is learned by the electronic device for the secondary training environment, and it may be used later to perform the corresponding task in an environment similar to the secondary training environment.

During the secondary training, the electronic device may acquire the current real-time observation information of the secondary training environment where it is located, and make a decision for the real-time observation information according to the secondary memory parameter and target meta-parameter. And after executing the decision, the electronic device may acquire the observation information of the secondary training environment at that time as the second observation information.

For example, if a current task of the electronic device is to reach a destination to pick up a target object at there, the electronic device may determine a relative location of the target object with respect to itself based on the real-time observation information, and make a decision according to the secondary memory parameter and the target meta-parameter, so that the electronic device may approach the target object by executing the decision. If the target meta-parameter and the secondary memory parameter are applicable to the secondary training environment where the electronic device is located, after executing the current decision, the electronic device may determine, by comparing the acquired second observation information with the previous real-time observation information, that the electronic device is getting close to the target object.

Specifically, the secondary memory parameter may be updated, and each time a new secondary memory parameter is obtained through updating, a piece of second observation information may be determined according to the current/new secondary memory parameter and the target meta-parameter.

For example, the electronic device may generate the secondary memory parameter η⁰ through initialization, and a decision α₀ may be made by using the target meta-parameter θ and η⁰. After executing the decision α₀, the electronic device may collect information of the secondary training environment to obtain the second observation information o₀.

The decision αₜ may be determined based on the following formula: αₜ = g(η^{t}, θ), where t is used to represent the number of iterations for the secondary memory parameter.

Specifically, the electronic device may acquire the second current observation information of the secondary training environment. For example, in a case where the electronic device has a sensor, the electronic device may use the sensor to collect information of the surrounding environment, so as to obtain the second current observation information.

Further, the electronic device may also generate secondary decision information corresponding to the second current observation information, according to the secondary memory parameter and the target meta-parameter. The secondary decision information generated by the electronic device is used to make a response to the second current observation information observed by the electronic device. For example, in a case where the second current observation information indicates that there is an obstacle in front of the electronic device, the generated secondary decision information may enable the electronic device to bypass the obstacle.

In practical applications, the electronic device may make a decision based on the secondary decision information, such as walking forward or backward. After executing the decision, the electronic device may collect the second observation information of the secondary training environment.

In this implementation, a large number of secondary memory parameters may be generated for one target meta-parameter, and each secondary memory parameter and the target meta-parameter may be used to make one secondary decision, and the second observation information may be obtained after the decision is executed. Thereafter, the secondary memory parameter is updated by using the second observation information obtained after the decision is executed and the parameters used for making the decision, and the target memory parameter applicable to the current training task may be obtained through multiple iterations.

In this way, the target meta-parameter is the general parameter of the model, and the target memory parameter is a parameter corresponding to the training environment, so that the electronic device obtains, through learning, the ability to perform tasks in the secondary training environment.

At step 213, the secondary memory parameter is updated according to the secondary memory parameter, the target meta-parameter and the second observation information, to obtain an updated secondary memory parameter.

Multiple secondary memory parameters may be determined with the target meta-parameter, so that a small number of meta-parameters may drive a large number of secondary memory parameters. In addition, the second observation information may also be determined for each secondary memory parameter. Thus, the second observation information may be used to update the secondary memory parameter, to obtain the final target memory parameter.

Specifically, the electronic device may update the secondary memory parameter to obtain the updated secondary memory parameter.

After the updated secondary memory parameter is obtained, step 212 and step 213 may be repeated for a preset number of times, until the target memory parameter is obtained through iteration.

Further, when updating the secondary memory parameter, the electronic device may specifically update it, according to the secondary memory parameter, the target meta-parameter, the secondary decision information and the second observation information, to obtain the updated secondary memory parameter.

Specifically, the secondary memory parameter may be updated based on the following formula:

$${η}_{i}^{t + 1} = f \left({η}_{i}^{t} , {o}_{t} , {a}_{t} ; {θ}_{k}^{i}\right) .$$

In practical applications, the electronic device may determine whether the condition for stopping the secondary training task is met currently. If it is determined that the condition for stopping the secondary training task is met, step 214 may be performed to determine the currently determined secondary memory parameter as the target memory parameter. If it is determined that the condition for stopping the secondary training task is not met, it may proceed to step 212 to perform operations therefrom with the updated secondary memory parameter, until it is determined that the condition for stopping the secondary training task is met.

The condition for stopping the secondary training task may be that: a training life cycle is met, or a preset time point is reached. For example, the electronic device may be trained all the time.

Specifically, after the training is completed, the current target memory parameter ηt of the electronic device may be used to make a decision, and this target memory parameter may no longer be updated. For example, the target meta-parameter and the target memory parameter may be provided in other electronic devices similar to the electronic device used for the training, so that other electronic devices may use the target meta-parameter and the target memory parameter, which are obtained through training, to make decisions.

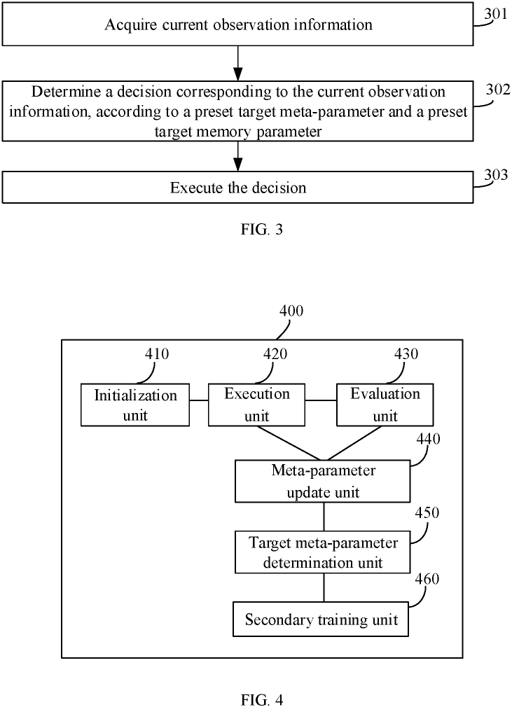

FIG. 3 is a schematic flowchart of a decision determination method provided by an exemplary embodiment of the present disclosure.

As shown in FIG. 3, the decision determination method provided by the present disclosure includes operations as follows. The decision determination method may be implemented by an electronic device.

At step 301, current observation information of an environment where the electronic device is located is acquired.

At step 302, a decision corresponding to the current observation information is determined, according to a preset target meta-parameter and a preset target memory parameter.

At step 303, the decision is executed.

The preset target meta-parameter and the preset target memory parameter are obtained based on any of the above training methods.

Specifically, the target meta-parameter and target memory parameter of the model, which are obtained through the training of the above solution, may be provided in the electronic device, and an environment similar to the above secondary training environment may be set for the electronic device. The electronic device may use the target meta-parameter and target memory parameter, which are obtained through the training, to perform tasks similar to the secondary training task, such as the task of picking up a target object, or routing inspection. That is, the model having the target meta-parameter and target memory parameter enables the electronic device to make decisions according to the environment thereof, so as to control operations of the electronic device for specific tasks.

Further, in a case where the electronic device is a robot, the current observation information of the surrounding environment may be collected with the sensor provided on the robot.

In a case where the electronic device is a computer, the environment of the computer is similar to the environment used for training the model. The data in the environments of different computers may be different, and the data input to the model is the current observation information of the environment where the model is located, for example, a sentence, or an image frame. The electronic device may process the current observation information and make decisions, according to the target meta-parameter and the target memory parameter in the model.

FIG. 4 is a schematic structural diagram of an apparatus for training a decision-making model parameter provided by an exemplary embodiment of the present disclosure.

The apparatus 400 for training a decision-making model parameter provided by the present disclosure includes:
an initialization unit 410, configured to acquire the initialized meta-parameter;
an execution unit 420, configured to generate a perturbation parameter according to the meta-parameter, and acquire first observation information of a primary training environment based on the perturbation parameter;
an evaluation unit 430, configured to determine an evaluation parameter of the perturbation parameter according to the first observation information;
a meta-parameter update unit 440, configured to generate an updated meta-parameter, according to the perturbation parameter and the evaluation parameter thereof;
a target meta-parameter determination unit 450, configured to determine the updated meta-parameter as a target meta-parameter, when it is determined, according to the meta-parameter and the updated meta-parameter, that a condition for stopping the primary training is met; and
a secondary training unit 460, configured to determine, according to the target meta-parameter, a target memory parameter corresponding to a secondary training task, where the target memory parameter and the target meta-parameter are configured to make a decision corresponding to a prediction task, and the prediction task corresponds to the secondary training task.

In the apparatus for training a decision-making model parameter provided by the embodiment of the present disclosure, during the primary training and the secondary training, there is no need to prepare training data in advance, the parameters are obtained through learning in multiple iterations by the electronic device without manual intervention, so that the training efficiency can be improved.

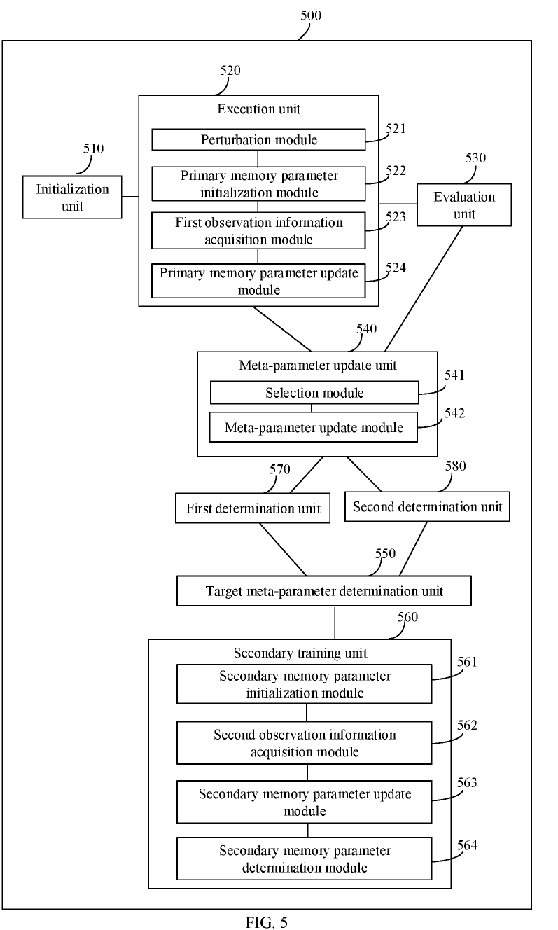

FIG. 5 is a schematic structural diagram of an apparatus for training a decision-making model parameter provided by another exemplary embodiment of the present disclosure.

In the apparatus 500 for training a decision-making model parameter provided by the present disclosure, an initialization unit 510 is similar to the initialization unit 410 shown in FIG. 4, an execution unit 520 is similar to the execution unit 420 shown in FIG. 4, an evaluation unit 530 is similar to the evaluation unit 430 shown in FIG. 4, a meta-parameter update unit 540 is similar to the meta-parameter update unit 440 shown in FIG. 4, a target meta-parameter determination unit 550 is similar to the target meta-parameter determination unit 450 shown in FIG. 4, and a secondary training unit 560 is similar to the secondary training unit 460 shown in FIG. 4.

In an implementation, the execution unit 520 is further configured to proceed to perform, with the updated meta-parameter, the step of generating a perturbation parameter according to the meta-parameter, when it is determined, according to the meta-parameter and the updated meta-parameter, that the condition for stopping the primary training task is not met.

In an implementation, the execution unit 520 includes a perturbation module 521 configured to:
generate multiple random perturbation values; and
add each of the random perturbation values with the meta-parameter, to obtain multiple perturbation parameters.

In an implementation, the execution unit 520 includes:
a primary memory parameter initialization module 522, configured to acquire an initialized primary memory parameter, for each of the perturbation parameters;
a first observation information acquisition module 523, configured to determine the first observation information of the primary training environment, according to the primary memory parameter and the perturbation parameter; and
a primary memory parameter update module 524, configured to update, according to the primary memory parameter, the perturbation parameter and the first observation information, the primary memory parameter to obtain an updated primary memory parameter;
where the first observation information acquisition module 523 is further configured to proceed to perform, with the updated primary memory parameter, the step of determining the first observation information of the primary training environment according to the primary memory parameter and the perturbation parameter, until T pieces of first observation information for the perturbation parameter is determined.

In an implementation, the first observation information acquisition module 523 is specifically configured to:
acquire first current observation information of the primary training environment, and generate, according to the primary memory parameter and the perturbation parameter, primary decision information corresponding to the first current observation information; and
make a decision according to the primary decision information, and acquire the first observation information of the primary training environment after the decision is executed.

The primary memory parameter update module 524 is specifically configured to: update, according to the primary memory parameter, the perturbation parameter, the primary decision information and the first observation information, the primary memory parameter to obtain the updated primary memory parameter.

In an implementation, multiple pieces of first observation information are acquired for the perturbation parameter, and the evaluation unit 530 is specifically configured to: determine the evaluation parameter of the perturbation parameter according to the individual pieces of first observation information for the perturbation parameter.

In an implementation, the meta-parameter update unit 540 includes:
a selection module 541, configured to determine at least one target perturbation parameter from the perturbation parameters, according to the evaluation parameters of the perturbation parameters; and
a meta-parameter update module 542, configured to generate the updated meta-parameter according to the at least one target perturbation parameter.

In an implementation, the apparatus further includes a first determination unit 570 configured to: determine that the condition for stopping the primary training task is met, when it is determined that a difference between the meta-parameter and the updated meta-parameter is less than a preset parameter threshold.

In the apparatus provided by the embodiment of the present disclosure, the evaluation unit 530 is further configured to determine an evaluation parameter of the meta-parameter, according to the evaluation parameter of the perturbation parameter of the meta-parameter.

The apparatus further includes a second determination unit 580 configured to: determine that the condition for stopping the primary training task is met, when it is determined that a difference between the evaluation parameter of the meta-parameter and that of the updated meta-parameter is less than a preset evaluation threshold.

In an implementation, the secondary training unit 560 includes:
a secondary memory parameter initialization module 561, configured to acquire an initialized secondary memory parameter;
a second observation information acquisition module 562, configured to determine second observation information of the secondary training environment, according to the secondary memory parameter and the target meta-parameter, where the secondary training environment corresponds to the secondary training task;
a secondary memory parameter update module 563, configured to update, according to the secondary memory parameter, the target meta-parameter and the second observation information, the secondary memory parameter to obtain an updated secondary memory parameter; and
a secondary memory parameter determination module 564, configured to determine the updated secondary memory parameter as the target memory parameter corresponding to the secondary training task, when it is determined that a condition for stopping the secondary training task is met;
where the second observation information acquisition module 562 is further configured to proceed to perform, with the updated secondary memory parameter, the step of determining, according to the secondary memory parameter and the target meta-parameter, the second observation information of the secondary training environment, when it is determined that the condition for stopping the secondary training task is not met.

In an implementation, the second observation information acquisition module 562 is specifically configured to:
acquire second current observation information of the secondary training environment, and generate, according to the secondary memory parameter and the target meta-parameter, secondary decision information corresponding to the second current observation information; and
make a decision according to the secondary decision information, and acquire the second observation information of the secondary training environment after the decision is executed.

The secondary memory parameter update module 563 is specifically configured to: update, according to the secondary memory parameter, the target meta-parameter, the secondary decision information and the second observation information, the secondary memory parameter to obtain the updated secondary memory parameter.

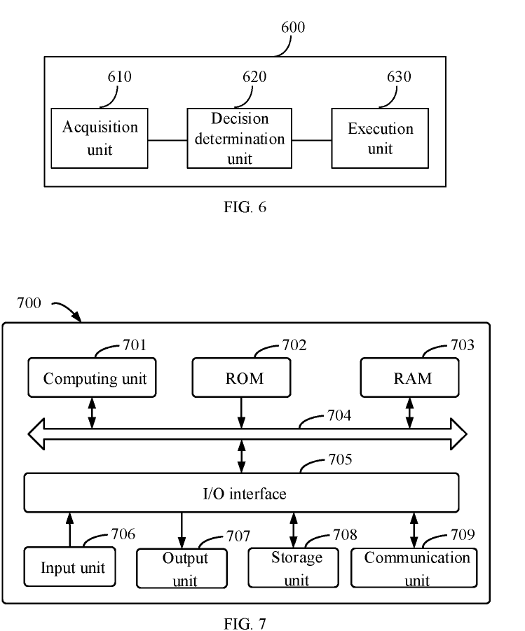

FIG. 6 is a schematic structural diagram of a decision determination apparatus provided by an exemplary embodiment of the present disclosure. The decision determination apparatus 600 may be implemented in an electronic device.

As shown in FIG. 6, the decision determination apparatus 600 provided by the present disclosure includes:
an acquisition unit 610, configured to acquire current observation information of an environment where the electronic device is located;
a decision determination unit 620, configured to determine a decision corresponding to the current observation information, according to a preset target meta-parameter and a preset target memory parameter; and
an execution unit 630, configured to execute the decision;
where the preset target meta-parameter and the preset target memory parameter are obtained through training based on any one of the apparatuses shown in FIG. 4 or FIG. 5.

The model parameter training method and apparatus, the decision determination method and apparatus, and the electronic device provided by the embodiments of the present disclosure are applied to deep learning technique in the field of artificial intelligence, which enable the training process of the model to be performed without preparing high-quality training data.

It should be noted that the model obtained through training in the embodiments is not a model specific to a specific user, and cannot reflect personal information of the specific user. It should be noted that the data in the embodiments comes from a public dataset.

In the technical solutions of the present disclosure, the acquisition, storage, usage, processing, transmission, provision, and releasing of the information involved herein are all in compliance with the provisions of relevant laws and regulations, and do not violate public order and good customs.

According to the embodiments of the present disclosure, the present disclosure further provides an electronic device, a non-transitory readable storage medium and a computer program product. According to an embodiment, the electronic device includes at least one processor and a memory communicating with the at least one processor. The memory stores therein instructions executable by the at least one processor, and the instructions are executed by the at least one processor to cause the at least one processor to perform the solution provided by any of the foregoing embodiments. According to an embodiment, the non-transitory computer-readable storage medium stores computer instructions, where the computer instructions, when being executed by an electronic device, cause the electronic device to perform the solution provided by any of the foregoing embodiments.

According to an embodiment of the present disclosure, the computer program product includes a computer program stored in a readable storage medium. At least one processor of the electronic device may read the computer program from the readable storage medium, and the at least one processor executes the computer program to cause the electronic device to perform the solution provided by any of the foregoing embodiments.

FIG. 7 is a schematic block diagram of an exemplary electronic device 700 for implementing the embodiments of the present disclosure. The electronic device is intended to represent various types of digital computers, such as a laptop, desktop, workstation, personal digital assistant, server, blade server, mainframe computer, and other suitable computers. The electronic device may also represent various types of mobile devices, such as a personal digital processor, cellular phone, smart phone, wearable device, and other similar computing devices. The components, their connections and relationships, as well as their functions shown herein are only exemplary, and are not intended to limit implementations of the present disclosure described and/or claimed herein.

As shown in FIG. 7, the device 700 includes a computing unit 701, which may perform, according to a computer program stored in a read-only memory (ROM) 702 or a computer program loaded from a storage unit 708 onto a random access memory (RAM) 703, various appropriate actions and processes. In the RAM 703, various programs and data required for the operations of the device 700 may also be stored. The computing unit 701, the ROM 702, and the RAM 703 are connected to each other through a bus 704. An input/output (I/O) interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices through a computer network such as the Internet and/or various telecommunication networks.

The computing unit 701 may be various general-purpose and/or special-purpose processing components with processing and computing capabilities. Some examples of the computing unit 701 include, but are not limited to, central processing unit (CPU), graphics processing unit (GPU), various dedicated artificial intelligence (AI) computing chips, various computing units that executes machine learning model algorithms, digital signal processor (DSP), and any appropriate processor, controller, microcontroller, etc. The computing unit 701 performs the various methods and processing described above, for example, the method for training a decision-making model parameter or the decision determination method. For example, in some embodiments, the method for training a decision-making model parameter or the decision determination method may be implemented as a computer software program, which is tangibly contained in a machine-readable medium, such as the storage unit 708. In some embodiments, a part or all of the computer program may be loaded and/or installed on the device 700 via the ROM 702 and/or the communication unit 709. When the computer program is loaded into the RAM 703 and executed by the computing unit 701, one or more steps of the method for training a decision-making model parameter or the decision determination method described above may be performed. Alternatively, in other embodiments, the computing unit 701 may be configured to perform, in any other suitable manner (for example, by means of firmware), the method for training a decision-making model parameter or the decision determination method.

Various implementations of the systems and techniques described above may be embodied in a digital electronic circuit system, an integrated circuit system, a field programmable gate array (FPGA), an application specific integrated circuit (ASIC), an application specific standard product (ASSP), a system-on-a-chip (SOC) system, a complex programmable logic device (CPLD), computer hardware, firmware, software, and/or combinations thereof. These various implementations may be embodied in one or more computer programs, and the one or more computer programs may be executed and/or interpreted on a programmable system including at least one programmable processor. The programmable processor may be a dedicated or general programmable processor, and may receive/transmit data and instructions from/to a storage system, at least one input apparatus, and at least one output apparatus.

The program codes used to implement the methods of the present disclosure may be written in any combination of one or more programming languages. These program codes may be provided to the processor or controller of a general-purpose computer, a special-purpose computer, or other programmable data processing devices, so that the program codes, when being executed by the processor or controller, cause the functions/operations specified in the flowchart and/or block diagram to be implemented. The program codes may be executed wholly or partly on a machine, and the program codes may be executed, as an independent software package, partly on the machine and partly on a remote machine, or the program codes may be executed wholly on the remote machine or a server.

In the context of the present disclosure, the machine-readable medium may be a tangible medium that may contain or store a program for use by, or for use together with, an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or may be any suitable combination thereof. More specific examples of the machine-readable storage medium may include electrical connection based on one or more wires, portable computer disk, hard disk, random access memory (RAM), read-only memory (ROM), erasable programmable read-only memory (EPROM), flash memory, optical fiber, portable compact disk read-only memory (CD-ROM), optical storage device, magnetic storage device, or any appreciate combination thereof.

In order to provide interaction with the user, the systems and techniques described herein may be implemented on a computer, and the computer has: a display device (for example, a cathode ray tube (CRT) or liquid crystal display (LCD) monitor) for displaying information to the user; and a keyboard and a pointing device (for example, a mouse or a trackball), where the user may provide input to the computer through the keyboard and the pointing device. Other types of devices may also be used to provide interaction with the user. For example, the feedback provided to the user may be any form of sensory feedback (for example, visual feedback, auditory feedback or tactile feedback); and the input from the user may be received in any form (including sound input, voice input or tactile input).

The systems and technologies described herein may be implemented in a computing system that includes back-end components (for example, a data server), or in a computing system that includes middleware components (for example, an application server), or in a computing system that includes front-end components (for example, a user computer with a graphical user interface or web browser, through which the user may interact with the implementation of the system and technology described herein), or in a computing system that includes any combination of such back-end components, middleware components, or front-end components. The components of the system may be connected to each other through any form or medium of digital data communication (for example, a communication network). Examples of the communication network include: local area network (LAN), wide area network (WAN) and the Internet.

The computer system may include a client and a server. The client and server are generally far away from each other and usually interact with each other through a communication network. The relationship between the client and the server is generated through computer programs running on the respective computers and having a client-server relationship with each other. The server may be a cloud server, which is also called cloud computing server or cloud host, and it is a host product in the cloud computing service system for solving the defects of difficult management and weak business expansion in the traditional physical host and Virtual Private Server (VPS). The server may also be a server of a distributed system, or a server combined with a block chain.

It should be understood that the various forms of processes shown above may be reordered, added with a step or made a step deleted therefrom. For example, the steps described in the present disclosure may be performed in parallel, sequentially, or in a different order, as long as the desired result of the technical solution disclosed in the present disclosure can be achieved, which is not limited herein.

The above specific implementations do not constitute a limitation on the scope of protection of the present disclosure. Those skilled in the art should understand that various modifications, combinations, sub-combinations, and substitutions may be made according to design requirements and other factors. Any amendments, equivalent substitutions and improvements, made within the spirit and principles of the present disclosure, shall be included in the scope of protection of the present disclosure.

What is claimed is:

1. A method for training a decision-making model parameter, implemented by an electronic device, the method comprising:
acquiring an initialized meta-parameter;
generating a perturbation parameter according to the meta-parameter, and acquiring first observation information of a primary training environment based on the perturbation parameter;
determining, according to the first observation information, an evaluation parameter of the perturbation parameter;
generating, according to the perturbation parameter and the evaluation parameter thereof, an updated meta-parameter;
determining the updated meta-parameter as a target meta-parameter, in response to determining, according to the meta-parameter and the updated meta-parameter, that a condition for stopping primary training is met; and
determining, according to the target meta-parameter, a target memory parameter corresponding to a secondary training task, wherein the target memory parameter and the target meta-parameter are configured to make a decision corresponding to a prediction task, and the prediction task corresponds to the secondary training task.

2. The method according to claim 1, further comprising: proceeding to perform, with the updated meta-parameter, a step of generating a perturbation parameter according to the meta-parameter, in response to determining, according to the meta-parameter and the updated meta-parameter, that the condition for stopping the primary training is not met.

3. The method according to claim 1, wherein the generating a perturbation parameter according to the meta-parameter, comprises:
generating a plurality of random perturbation values; and
adding each of the plurality of random perturbation values with the meta-parameter, to obtain a plurality of perturbation parameters.

4. The method according to claim 3, wherein the acquiring first observation information of a primary training environment based on the perturbation parameter, comprises:
for each of the plurality of perturbation parameters,
acquiring an initialized primary memory parameter;
determining, according to the primary memory parameter and the perturbation parameter, the first observation information of the primary training environment; and
updating, according to the primary memory parameter, the perturbation parameter and the first observation information, the primary memory parameter to obtain an updated primary memory parameter, and proceeding to perform, with the updated primary memory parameter, a step of determining, according to the primary memory parameter and the perturbation parameter, the first observation information of the primary training environment, until T pieces of first observation information for the perturbation parameter are determined.

5. The method according to claim 4, wherein the determining, according to the primary memory parameter and the perturbation parameter, the first observation information of the primary training environment, comprises:
acquiring first current observation information of the primary training environment, and generating, according to the primary memory parameter and the perturbation parameter, primary decision information corresponding to the first current observation information; and
making a decision according to the primary decision information, and acquiring the first observation information of the primary training environment after the decision is executed; and
the updating, according to the primary memory parameter, the perturbation parameter and the first observation information, the primary memory parameter to obtain an updated primary memory parameter, comprises:
updating, according to the primary memory parameter, the perturbation parameter, the primary decision information and the first observation information, the primary memory parameter to obtain an updated primary memory parameter.

6. The method according to claim 3, wherein a plurality of pieces of first observation information are acquired for each of the perturbation parameters;
the determining, according to the first observation information, an evaluation parameter of the perturbation parameter, comprises:
determining, according to individual pieces of first observation information for each of the perturbation parameters, the evaluation parameter of the perturbation parameter.

7. The method according to claim 3, wherein the generating, according to the perturbation parameter and the evaluation parameter thereof, an updated meta-parameter, comprises:
determining, according to the evaluation parameters of the perturbation parameters, at least one target perturbation parameter from the perturbation parameters; and
generating the updated meta-parameter according to the at least one target perturbation parameter.

8. The method according to claim 1, further comprising: determining that the condition for stopping the primary training is met, in response to determining that a difference between the meta-parameter and the updated meta-parameter is less than a preset parameter threshold.

9. The method according to claim 1, further comprising:
determining, according to the evaluation parameter of the perturbation parameter of the meta-parameter, an evaluation parameter of the meta-parameter; and
determining that the condition for stopping the primary training is met, in response to determining that a difference between the evaluation parameter of the meta-parameter and an evaluation parameter of the updated meta-parameter is smaller than a preset evaluation threshold.

10. The method according to claim 1, wherein the determining, according to the target meta-parameter, a target memory parameter corresponding to a secondary training task, comprises:
acquiring an initialized secondary memory parameter;
determining, according to the secondary memory parameter and the target meta-parameter, second observation information of a secondary training environment, wherein the secondary training environment corresponds to the secondary training task;
updating, according to the secondary memory parameter, the target meta-parameter and the second observation information, the secondary memory parameter to obtain an updated secondary memory parameter;
determining the updated secondary memory parameter as the target memory parameter corresponding to the secondary training task, in response to determining that a condition for stopping the secondary training task is met; and
proceeding to perform, with the updated secondary memory parameter, a step of determining, according to the secondary memory parameter and the target meta-parameter, second observation information of a secondary training environment, in response to determining that the condition for stopping the secondary training task is not met.

11. The method according to claim 10, wherein the determining, according to the secondary memory parameter and the target meta-parameter, second observation information of a secondary training environment, comprises:
acquiring second current observation information of the secondary training environment, and generating, according to the secondary memory parameter and the target meta-parameter, secondary decision information corresponding to the second current observation information; and
making a decision according to the secondary decision information, and acquiring the second observation information of the secondary training environment after the decision is executed; and
the updating, according to the secondary memory parameter, the target meta-parameter and the second observation information, the secondary memory parameter to obtain an updated secondary memory parameter, comprises:
updating, according to the secondary memory parameter, the target meta-parameter, the secondary decision information and the second observation information, the secondary memory parameter to obtain an updated secondary memory parameter.

12. A decision determination method, implemented by an electronic device, the method comprising:
acquiring current observation information of an environment where the electronic device is located;
determining, according to a preset target meta-parameter and a preset target memory parameter, a decision corresponding to the current observation information; and
executing the decision;
wherein the preset target meta-parameter and the preset target memory parameter are obtained through training based on the method according to claim 1.

13. An electronic device, comprising:
at least one processor; and
a memory communicating with the at least one processor;
wherein the memory stores instructions executable by the at least one processor, and the instructions are executed by the at least one processor to cause the at least one processor to:
acquire an initialized meta-parameter;
generate a perturbation parameter according to the meta-parameter, and acquire first observation information of a primary training environment based on the perturbation parameter;
determine, according to the first observation information, an evaluation parameter of the perturbation parameter;
generate, according to the perturbation parameter and the evaluation parameter thereof, an updated meta-parameter;
determine the updated meta-parameter as a target meta-parameter, when it is determined, according to the meta-parameter and the updated meta-parameter, that a condition for stopping primary training is met; and
determine, according to the target meta-parameter, a target memory parameter corresponding to a secondary training task, wherein the target memory parameter and the target meta-parameter are configured to make a decision corresponding to a prediction task, and the prediction task corresponds to the secondary training task.

14. The electronic device according to claim 13, wherein the instructions further cause the at least one processor to: proceed to perform, with the updated meta-parameter, a step of generating a perturbation parameter according to the meta-parameter, when it is determined, according to the meta-parameter and the updated meta-parameter, that the condition for stopping the primary training is not met.

15. The electronic device according to claim 13, wherein the instructions further cause the at least one processor to:
generate a plurality of random perturbation values; and
add each of the plurality of random perturbation values with the meta-parameter, to obtain a plurality of perturbation parameters.

16. The electronic device according to claim 15, wherein the instructions further cause the at least one processor to:
for each of the plurality of perturbation parameters,
acquire an initialized primary memory parameter;
determine, according to the primary memory parameter and the perturbation parameter, the first observation information of the primary training environment;
update, according to the primary memory parameter, the perturbation parameter and the first observation information, the primary memory parameter to obtain an updated primary memory parameter; and
proceed to perform, with the updated primary memory parameter, a step of determining, according to the primary memory parameter and the perturbation parameter, the first observation information of the primary training environment, until T pieces of first observation information for the perturbation parameter are determined.

17. The electronic device according to claim 16, wherein the instructions further cause the at least one processor to:
acquire first current observation information of the primary training environment, and generate, according to the primary memory parameter and the perturbation parameter, primary decision information corresponding to the first current observation information;
make a decision according to the primary decision information, and acquire the first observation information of the primary training environment after the decision is executed; and
update, according to the primary memory parameter, the perturbation parameter, the primary decision information and the first observation information, the primary memory parameter to obtain the updated primary memory parameter.

18. The electronic device according to claim 13, wherein the instructions further cause the at least one processor to:
determine that the condition for stopping the primary training is met, when it is determined that a difference between the meta-parameter and the updated meta-parameter is less than a preset parameter threshold; or
determine, according to the evaluation parameter of the perturbation parameter of the meta-parameter, an evaluation parameter of the meta-parameter; and determine that the condition for stopping the primary training is met, when it is determined that a difference between the evaluation parameter of the meta-parameter and an evaluation parameter of the updated meta-parameter is smaller than a preset evaluation threshold.

19. The electronic device according to claim 13, wherein the instructions further cause the at least one processor to:
acquire an initialized secondary memory parameter;
determine, according to the secondary memory parameter and the target meta-parameter, second observation information of a secondary training environment, wherein the secondary training environment corresponds to the secondary training task;
update, according to the secondary memory parameter, the target meta-parameter and the second observation information, the secondary memory parameter to obtain an updated secondary memory parameter;
determine the updated secondary memory parameter as the target memory parameter corresponding to the secondary training task, when it is determined that a condition for stopping the secondary training task is met; and
proceed to perform, with the updated secondary memory parameter, a step of determining, according to the secondary memory parameter and the target meta-parameter, second observation information of a secondary training environment, when it is determined that the condition for stopping the secondary training task is not met.

20. A non-transitory computer-readable storage medium storing computer instructions, wherein the computer instructions, when being executed by an electronic device, cause the electronic device to perform a method for training a decision-making model parameter, the method comprising:
acquiring a meta-parameter obtained through initialization;
generating a perturbation parameter according to the meta-parameter, and acquiring first observation information of a primary training environment based on the perturbation parameter;
determining, according to the first observation information, an evaluation parameter of the perturbation parameter;
generating, according to the perturbation parameter and the evaluation parameter thereof, an updated meta-parameter;
determining the updated meta-parameter as a target meta-parameter, in response to determining, according to the meta-parameter and the updated meta-parameter, that a condition for stopping primary training is met; and
determining, according to the target meta-parameter, a target memory parameter corresponding to a secondary training task, wherein the target memory parameter and the target meta-parameter are configured to make a decision corresponding to a prediction task, and the prediction task corresponds to the secondary training task.
